(19) United States
(12) Patent Application Publication
(10) Pub. No.: US 2025/0100074 A1
(43) Pub. Date: Mar. 27, 2025

(54) MACHINING SYSTEM AND METHOD FOR LASER MACHINING A WORKPIECE

(71) Applicant: TRUMPF Laser GmbH, Schramberg (DE)

(72) Inventors: Daniel Großmann, Schramberg (DE); Malte Kumkar, Weimar (DE)

(21) Appl. No.: 18/974,835

(22) Filed: Dec. 10, 2024

Related U.S. Application Data
(63) Continuation of application No. PCT/EP2023/065257, filed on Jun. 7, 2023.

(30) Foreign Application Priority Data
Jun. 13, 2022 (DE) 10 2022 114 763.0

(51) Int. Cl. B23K 26/06; B23K 26/0622; B23K 26/08; B23K 26/082

(52) U.S. Cl. CPC B23K 26/0604; B23K 26/0624; B23K 26/082; B23K 26/083; B23K 26/0869

(57) ABSTRACT

A machining system for laser machining a workpiece includes a laser beam source for providing a plurality of coherent laser beams, a phase adjustment unit for adjusting a respective phase difference between the plurality of coherent laser beams, an amplifier for amplifying the plurality of coherent laser beams to form respective amplified coherent laser beams, a processing optic for combining the amplified coherent laser beams to form a machining laser beam and for applying the workpiece with the machining laser beam, a feed unit for controlling a position and/or an orientation and/or a movement status of the workpiece relative to the machining laser beam, a detection unit for determining a status of the feed unit, and a control unit configured to control the phase adjustment unit according to the status of the feed unit as determined by the detection unit.

### CROSS REFERENCE TO RELATED APPLICATIONS

This application is a continuation of International Application No. PCT/EP2023/065257 (WO 2023/242025 A1), filed on Jun. 7, 2023, and claims benefit to German Patent Application No. DE 10 2022 114 763.0, filed on Jun. 13, 2022. The aforementioned applications are hereby incorporated by reference herein.

### FIELD

Embodiments of the present invention relate to a machining system and a method for laser machining a workpiece.

### BACKGROUND

DE 10 2020 201 161 A1 disclosed an apparatus for combining a plurality of coherent laser beams, comprising a splitting device for splitting an input laser beam into the plurality of coherent laser beams, a plurality of phase adjustment units for adjusting a respective phase of one of the coherent laser beams, and a beam combination unit for combining the coherent laser beams, which emanate from a plurality of grid positions of a grid arrangement, to form at least one combined laser beam, wherein the beam combination unit has a microlens arrangement with exactly one microlens array for forming the at least one combined laser beam.

From WO 2017/125345 A1 is known a phase control system for controlling the relative phase of two laser beams of a laser system to be coherently combined, which is intended for providing a phase-controlled sum laser beam.

From WO 2020/016824 A1 is known a method for determining phase shifts of several beams of a coherent beam combining unit impinging on a target.

From EP 3 597 405 A1, a device for additively producing three-dimensional objects by successively irradiating and solidifying layers of a building material by means of an energy beam is known, wherein an irradiation device is provided which is designed to generate at least two coherently stimulated energy beams, wherein the irradiation device comprises a modulation unit which is designed to combine the at least two energy beams into a combined energy beam and to adjust at least one combined beam property of the combined energy beam.

From WO 2019/092702 A2, a laser system is known comprising a seed laser, a subsystem for splitting and combining laser beams that receives an output from the seed laser and provides a combined laser output with noise, and a noise suppression subsystem that serves to provide a noise suppression phase correction output based on taking the noise into account at a noise sampling rate, wherein the subsystem for splitting and combining laser beams changes a phase of the combined laser output at a phase variation rate that exceeds the noise sampling rate.

### SUMMARY

Embodiments of the present invention provide a machining system for laser machining a workpiece. The machining system includes at least one laser beam source for providing a plurality of coherent laser beams, a phase adjustment unit for adjusting a respective phase difference between the plurality of coherent laser beams, and an amplifier for amplifying the plurality of coherent laser beams to form respective amplified coherent laser beams, a processing optic for combining the amplified coherent laser beams to form at least one machining laser beam and for applying the workpiece with the at least one machining laser beam, a feed unit for controlling a position and/or an orientation and/or a movement status of the workpiece relative to the at least one machining laser beam, a detection unit for determining a status of the feed unit, and a control unit configured to control the phase adjustment unit according to the status of the feed unit as determined by the detection unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an exemplary embodiment of a machining system; and

FIG. 2 shows a plan view of a workpiece which is arranged on a mount of the machining system, according to some embodiments.

### DETAILED DESCRIPTION

Embodiments of the present invention provide a machining system for laser machining of a workpiece, which enables versatile and flexible laser machining of the workpiece with dynamically adjustable beam parameters.

According to some embodiments, a machining system includes at least one laser beam source for providing a plurality of coherent laser beams, a phase adjustment unit for adjusting a respective phase difference between the coherent laser beams, an amplifying unit for amplifying the coherent laser beams, whereby respective amplified coherent laser beams are formed by amplifying the respective coherent laser beams, a processing optic for combining the amplified coherent laser beams to form at least one machining laser beam and for applying the workpiece with the at least one machining laser beam, a feed unit for controlling a position and/or orientation and/or a movement status of the workpiece relative to the at least one machining laser beam, a detection unit for determining a status of the feed unit, and a control unit for controlling the phase adjustment unit, wherein the control unit is designed to control the phase adjustment unit according to the status of the feed unit determined by the detection unit.

The machining system according to embodiments of the invention enables the control of the phase adjustment unit and thus the control of the phase differences between the coherent laser beams and amplified coherent laser beams according to the status of the feed unit, for example according to a position or speed of the at least one machining laser beam relative to the workpiece. By adjusting the phase differences between the coherent laser beams and amplified coherent laser beams, properties and/or beam parameters of at least one machining laser beam can be adjusted. This allows the properties and/or beam parameters of at least one machining laser beam to be adapted according to the status of the feed unit.

By adjusting the respective phase difference between the coherent laser beams, different beam parameters and/or properties of the at least one machining laser beam can be adjusted. This makes it possible, for example, to dynamically adapt the beam parameters and/or properties of the at least one machining laser beam according to its position or speed relative to the workpiece. For example, the phase differences can be varied by means of the control unit such that the machining laser beam has different beam parameters and/or properties in different spatial regions of the workpiece.

For example, by adjusting the respective phase difference between the coherent laser beams, the following beam parameters and/or properties of the existing machining laser beam or beams can be adjusted:
a number of existing machining laser beams
an intensity and/or polarization of the machining laser beam or the respective machining laser beams
a spatial beam shape and/or a spatial beam profile of the machining laser beam or the respective machining laser beams
a temporal sequence and/or a temporal pulse shape of pulses which are assigned to the machining laser beam or the respective machining laser beams

In particular, the processing optic is suitable for focusing the at least one machining laser beam on and/or into the workpiece.

The feed unit is suitable for applying the machining laser beam to the workpiece at predetermined positions as a function of time and/or for applying the machining laser beam to predetermined orientations and/or movement statuses. For example, a trajectory can be specified along which the at least one machining laser beam is moved relative to the workpiece. The feed unit can, for example, be programmed to apply the machining laser beam to the workpiece as part of a specific laser machining operation.

For example, the amplifying unit may comprise a fiber amplifier, slab amplifier, rod amplifier or disk amplifier.

It can be provided that the amplifying unit comprises a frequency conversion stage or the amplifying unit is assigned a frequency conversion stage of the machining system.

In particular, a respective phase difference between the coherent laser beams and/or between the amplified coherent laser beams can be adjusted by means of the phase adjustment unit. In particular, a change in the phase difference between the coherent laser beams performed by means of the phase adjustment unit brings about a change in the phase difference between the corresponding amplified coherent laser beams.

In particular, a smallest time interval with which the status of the feed unit can be determined by means of the detection unit or is determined during operation of the machining system is in the range of 1 ns to 1 μs. On this time scale, the phase adjustment unit and the resulting adjustment of the respective phase difference between the coherent laser beams can be carried out, in particular by means of the control unit.

For example, the amplifying unit is arranged after the phase adjustment unit. In particular, the respective phase differences between the coherent laser beams are then adjusted by means of the phase adjustment unit before they are coupled into the amplifying unit. However, as an alternative, it is also possible in principle for the phase adjustment unit to be arranged after the amplifying unit.

The workpiece may, for example, be transparent, partially transparent or opaque for a wavelength of the at least one machining laser beam. For example, the workpiece may comprise or consist of a ceramic material and/or metal material and/or organic material and/or polymer material and/or glass material and/or crystal material and/or semiconductor material.

In particular, the status of the feed unit is or comprises a position of the workpiece relative to the at least one machining laser beam.

In particular, the status of the feed unit is or comprises an orientation of the workpiece relative to the at least one machining laser beam. For example, the status of the feed unit is or comprises an incidence angle of the at least one machining laser beam relative to a reference plane of the workpiece.

In particular, the status of the feed unit is or comprises a movement status of the workpiece relative to the at least one machining laser beam, for example a speed and/or acceleration of the workpiece relative to the at least one machining laser beam. The status of the feed unit can in particular comprise the speed and/or acceleration with respect to a translation and/or rotation of the workpiece.

In particular, it can be provided that the control unit is designed to adjust the respective phase difference between the coherent laser beams and/or the amplified coherent laser beams according to the status of the feed unit by controlling the phase adjustment unit. In particular, the respective phase difference can be adjusted to a predetermined target value by means of the control unit according to the status of the feed unit. This enables an adjustment of different properties of at least one machining laser beam according to the status of the feed unit.

In particular, it can be provided that the status of the feed unit that can be determined or is determined by means of the detection unit is an actual status and/or a target status of the feed unit. The control of the phase adjustment unit or the adjustment of the respective phase difference between the coherent laser beams can then be carried out according to the determined actual status and/or target status of the feed unit.

The target status is to be understood in particular as a status of the feed unit to be achieved based on current settings of the feed unit, for example a position or speed to be achieved of the at least one machining laser beam relative to the workpiece. The actual status is to be understood in particular as a measured and/or actual status of the feed unit, preferably by means of a sensor unit, for example a measured position or speed of the at least one machining laser beam relative to the workpiece.

It may be advantageous if the feed unit has a scanner unit, wherein the scanner unit in particular comprises an acoustooptical deflector and/or a scanner mirror and/or a galvanometer scanner. This allows the at least one output laser beam to be positioned and/or moved relative to the workpiece by means of the feed unit.

It may be advantageous if the machining system comprises a mount for arranging and/or fixing the workpiece. In particular, the feed unit is then assigned to the mount and is designed to move and/or to orientate the workpiece arranged on the mount relative to the at least one machining laser beam.

The fact that the feed unit is assigned to the mount and is designed to move and/or to orientate the workpiece arranged on the mount relative to the at least one machining laser beam does not necessarily mean that (viewed in the laboratory system) the mount is actually moved and/or displaced spatially. It is also possible that other components of the machining system (viewed in the laboratory system) are moved and/or displaced spatially in order to move the at least one machining laser beam relative to the workpiece. For example, a gantry system can be provided for this purpose.

The stated relative movement between the mount and the workpiece arranged thereon on the one hand and the at least one machining laser beam on the other hand can be realized by means of the feed unit (viewed in the laboratory system), for example by moving the mount and/or by moving beam guide components of the at least one machining laser beam and/or by moving the processing optic.

For example, the workpiece can be moved translationally and/or rotationally relative to the machining laser beam by means of the mount. The translational movement occurs, for example, along two and preferably along three spatial axes. The rotational movement occurs, for example, around at least two spatial axes.

It may be advantageous if the detection unit has a sensor unit for determining an actual status of the feed unit, wherein the sensor unit is in particular assigned to one or more components of the machining system which are designed to move and/or to orientate the at least one machining laser beam relative to the workpiece. These components are assigned to the feed unit and/or are part of the feed unit and by means of these components the position and/or orientation and/or the movement status of the workpiece relative to the at least one machining laser beam can be adjusted.

For example, these components can be a scanner unit of the feed unit and/or an acoustooptical deflector of the feed unit and/or a mount assigned to the feed unit for arranging the workpiece and/or a beam guide of the at least one machining laser beam and/or the processing optic.

For example, the sensor unit comprises one or more sensor elements to determine the actual status of the feed unit. This makes it possible to determine the actual status of the feed unit in a technically simple and reliable manner.

In particular, the sensor unit can comprise one or more sensor elements which are formed as a position sensor and/or speed sensor. This allows, for example, the positions and speeds of a scanner mirror and/or a galvanometer scanner and/or a mount to be recorded in a technically simple way in order to determine the actual status of the feed unit.

Furthermore, the sensor unit can, for example, have one or more sensor elements formed as temperature sensors. This makes it possible, for example, to determine temperature-dependent deviations in the position or speed of the at least one machining laser beam relative to the workpiece in the case of an acoustooptical deflector.

It may be advantageous if the detection unit is designed to read and/or process data from the feed unit in order to determine the target status of the feed unit. In particular, the data read out and/or processed by means of the detection unit are data relevant for adjusting the target status of the feed unit. In particular, the read and/or processed data contain the target status of the feed unit at a specific point in time.

In particular, it can be provided that the control of the phase adjustment unit is carried out by means of the control unit on the basis of a predetermined assignment rule. It may then be advantageous if the assignment rule has at least two different predefined parameter sets, which are selected according to the status of the feed unit determined by means of the detection unit.

The assignment rule contains in particular an assignment of statuses of the feed unit to phase differences to be adjusted between the coherent laser beams.

A predefined parameter set is or contains a specification for the phase differences to be adjusted between the respective coherent laser beams according to the determined status of the feed unit, i.e., a specification for which phase differences are adjusted according to a determined status of the feed unit by means of the control unit by controlling the phase adjustment unit.

During operation of the machining system, the parameter sets are selected on a smallest time scale in the range of 1 ns to 1 μs.

In one variant, it can be provided that the assignment rule and/or the predefined parameter sets are not changed during operation of the machining system.

Alternatively, it is also possible for the assignment rule and/or the predefined parameter sets to be adapted and/or optimized during operation of the machining system, whereby this can be done in particular on a smallest time scale of 1 μs to 1 μs.

In particular, it can be provided that the coherent laser beams provided by means of the laser beam source are pulsed laser beams and in particular ultrashort pulse laser beams, and/or that the at least one machining laser beam is a pulsed laser beam and in particular an ultrashort pulse laser beam. Ultrashort pulse laser beams can be used advantageously for precise and low-damage micro-material processing.

In principle, it is also possible that the coherent laser beams and/or the at least one machining laser beam are continuous wave laser beams.

According to embodiments of the invention, a method for laser machining of a workpiece is provided, wherein in which a plurality of coherent laser beams are provided, a respective phase difference between the coherent laser beams is adjusted, the coherent laser beams are amplified, wherein respective amplified coherent laser beams are formed by amplifying the respective coherent laser beams, the amplified coherent laser beams are combined to form the at least one machining laser beam and the at least one machining laser beam is applied to the workpiece, a position and/or an orientation and/or a movement status of the workpiece relative to the at least one machining laser beam is controlled by means of a feed unit, a status of the feed unit is determined by means of a detection unit, and the phase adjustment unit is controlled by means of a control unit, wherein the control unit controls the phase adjustment unit according to the status of the feed unit determined by means of the detection unit.

In particular, the method according to embodiments of the invention has one or more further features and/or advantages of the machining system according to embodiments of the invention. In particular, the method according to embodiments of the invention is carried out by means of the machining system according to embodiments of the invention and/or the machining system according to embodiments of the invention is suitable for carrying out the method according to embodiments of the invention.

The fact that a first unit and/or a first element of the machining system is arranged after a second unit and/or a second element of the machining system is to be understood in the present case as meaning that the laser beams guided in the machining system, such as the input laser beam and/or the coherent laser beams and/or the amplified coherent laser beams, first impinge on the second unit and/or the second element and then on the first unit and/or the first element. Then, the second unit and/or the second element is arranged upstream of the first unit and/or the first element. These specifications must always be related to the main propagation direction of the laser beams guided through the machining system.

In the following preferred embodiments are described in greater detail with reference to the drawings.

Elements that are the same or have equivalent functions are provided with the same reference symbols in all of the figures.

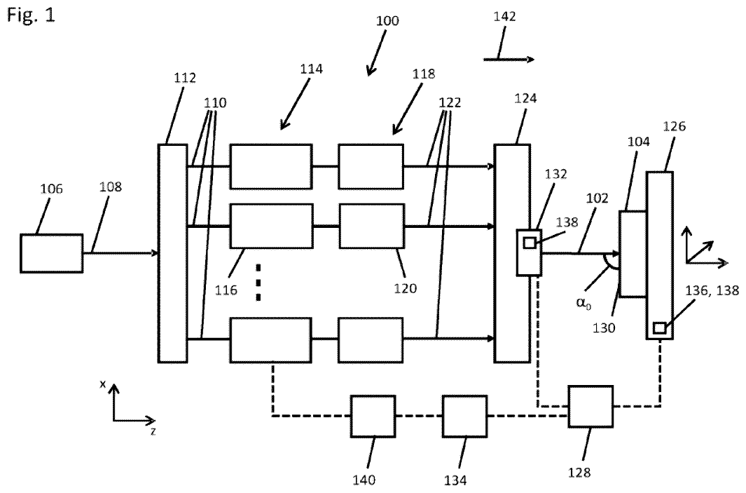

An exemplary embodiment of a machining system is schematically shown in FIG. 1 and is designated therein by 100. By means of the machining system 100, at least one machining laser beam 102 can be provided, which is intended for laser machining a workpiece 104.

In the exemplary embodiment shown in FIG. 1, the machining system 100 comprises a laser beam source 106, by means of which an input laser beam 108 is provided, wherein a plurality of coherent laser beams 110 are formed by splitting the input laser beam 108.

In principle, it is also possible that several laser beam sources 106 are provided for providing the coherent laser beams 110. For example, one or more coherent laser beams are then provided by means of a respective laser beam source 106.

A splitting device 112 is provided, for example, for splitting the input laser beam 108 into a plurality of coherent laser beams 110. For example, FIG. 1 shows three coherent laser beams 110, which are formed by splitting the input laser beam 108 by means of the splitting device 110.

The input laser beam 108 and/or the coherent laser beams 110 are, for example, pulsed laser beams and, in particular, ultrashort pulse laser beams.

In particular, the coherent laser beams 110 have the same properties, for example the same wavelength and/or the same spectrum.

A phase adjustment unit 114 is provided for adjusting a respective phase difference between the individual coherent laser beams 110. In particular, the phase adjustment unit 114 comprises a plurality of phase adjustment elements 116, wherein a phase of a coherent laser beam 110 assigned to this phase adjustment element 116 can be adjusted by means of a specific phase adjustment element 116. For example, a plurality or all of the coherent laser beams 110 are assigned a respective phase adjustment element 116.

In the case of N coherent laser beams 110, the phase adjustment unit 114 comprises for example N-1 or N phase adjustment elements 116. In particular, this makes it possible to adjust a respective phase difference between all existing coherent laser beams 110.

For the technical details of combining coherent laser beams, please refer to the scientific publications “Coherent combination of ultrafast fiber amplifiers”, Hanna, et al., Journal of Physics B: Atomic, Molecular and Optical Physics 49(6) (2016), 062004; “Performance scaling of laser amplifiers via coherent combination of ultrashort pulses”, Klenke, Mensch and Buch Verlag; “Coherent beam combining with an ultrafast multicore Yb-doped fiber amplifier”, Ramirez, et al., Optics Express 23(5), (2015), 5406-5416; and “Highly scalable femtosecond coherent beam combining demonstrated with 19 fibers”, Le Dortz, et al., Optics Letters 42(10), (2017), 1887-1890.

The machining system 100 comprises an amplifying unit 118 for amplifying the coherent laser beams 110, in order to amplify the respective coherent laser beams 110. In particular, the amplifying unit 118 comprises a plurality of amplifying elements 120, wherein, for example, one amplifying element 120 is assigned respectively to each of the coherent laser beams 110.

In the example shown in FIG. 1, the amplifying unit 118 or the amplifying elements 120 are arranged after the phase adjustment unit 114 or the phase adjustment elements 116. For example, coherent laser beams 110 decoupled from the phase adjustment unit 114 are coupled into the amplifying unit 118. In particular, the respective phase differences between the coherent laser beams 110 are adjusted by means of the phase adjustment unit 114 before they are coupled into the amplifying unit 118.

The coherent laser beams 110 which were amplified by means of the amplifying unit 118 are referred to hereinbelow as amplified coherent laser beams 122. In the example shown, the number of coherent laser beams 110 present corresponds to the number of amplified coherent laser beams 122 present.

To combine the amplified coherent laser beams 122 into the machining laser beam 102, the machining system 100 comprises a processing optic 124.

For example, amplified coherent laser beams 122 coupled out of the amplifying unit 118 are coupled into the processing optic 124. The machining laser beam 102 is then formed by combining these amplified coherent laser beams 122 by means of the processing optic 124.

For example, the processing optic 124 may comprise a diffractive optical element and/or a grating structure and/or a microlens array and/or a focusing element.

For technical details on the combination of coherent laser beams using diffractive optical elements, reference is made to the scientific publications “Coherent combination of ultrashort pulse beams using two diffractive optics”, Zhou et al., Opt. Latvian. 42, 4422-4425 (2017) and “Diffractive-optics-based beam combination of a phase-locked fiber laser array”, Cheung et al., Opt. Latvian. 33, 354-356 (2008) and for the combination of coherent laser beams by means of one or more microlens arrays, reference is made to WO 2020/016336 A1 and DE 10 2020 201 161 A1.

The processing optic 124 is designed to introduce and/or focus the formed machining laser beam 102 into the workpiece 102.

The workpiece 104 on which the laser machining is to be carried out is arranged and/or fixed and/or secured, for example, to a mount 126 of the machining system 100. In particular, the workpiece 102 can be positioned and/or moved and/or tilted and/or rotated relative to the machining laser beam 102 by means of the mount 126.

For example, the workpiece 104 can be moved by means of the mount 126 in three different spatial directions and/or along three different spatial axes (indicated by arrows in FIG. 1, which there correspond, for example, to the x-, y-and z-axes). For example, the workpiece 104 can then be rotatable about one or more of these spatial axes by means of the mount 126.

For example, it can be provided that one or more mounts 126 are arranged and/or formed on a conveyor belt. For example, a plurality of workpieces 104 can be arranged one after the other on the conveyor belt in order to process them one after the other by means of the machining laser beam 102.

The machining system 100 has a feed unit 128, by means of which a position x₀, y₀, z₀ and/or an orientation and/or a movement status of the workpiece 104 relative to the machining laser beam 102 are controllable. In particular, a translation and/or a rotation of the workpiece 104 relative to the machining laser beam 102 can be controlled by means of the feed unit 128.

Position x₀, y₀, z₀ or the movement status is to be understood in particular as a position or a movement status of a focus assigned to the machining laser beam 102 or of a focus zone assigned to the machining laser beam 102 relative to the workpiece 104. Accordingly, the orientation can be understood as an orientation of the focus or the focus zone of the machining laser beam 102 relative to the workpiece 104.

The feed unit 128 is in particular designed to introduce the at least one machining laser beam 102 into the workpiece 104 according to the time at predetermined positions and/or with predetermined orientations and/or with predetermined movement states.

The movement status of the workpiece 104, for example, is understood to mean a velocity v₀ and/or an acceleration a₀ of the workpiece 104 relative to the machining laser beam 102 with regard to translation or rotation.

The orientation of the workpiece 104 is understood to be, for example, an incidence angle α₀ of the machining laser beam 102 relative to a reference plane 130 of the workpiece 104, on which the machining laser beam 102 is incident. In the example shown, the reference plane 130 is an outer side of the workpiece 104 onto which the machining laser beam 102 is incident.

In one embodiment, the feed unit 128 is assigned to the mount 126 and/or the mount 126 is part of the feed unit 128. The feed unit 128 is then designed to move the mount 126 with the workpiece 104 arranged thereon relative to the machining laser beam 102, whereby the position and/or the orientation and/or the movement status of the workpiece 104 relative to the machining laser beam 102 can be controlled by means of the feed unit 128.

Alternatively or additionally, it can be provided that the feed unit 128 is assigned to the processing optic 124 and/or a beam guide of the machining laser beam 102 of the machining system 100 in order to control the position, orientation and/or movement status of the machining laser beam 102 relative to the workpiece 104. In particular, the processing optic 124 and/or the beam guide can then be controlled and/or moved by means of the feed unit 128 in order to control the said position, orientation and/or the said movement status.

It can be provided that the machining system 100 has a scanner unit 132, by means of which the position, orientation and/or movement status of the machining laser beam 102 relative to the workpiece 104 can be controlled. By means of the scanner unit 132, the machining laser beam 102 can be positioned and/or moved and/or aligned relative to the workpiece 104.

The scanner unit 132, for example, is arranged after a combination of the amplified coherent laser beams 122 by means of the processing optic 124 and/or before a focusing of the amplified coherent laser beams 122 by means of the processing optic 124 (indicated in FIG. 1). For example, the scanner unit 132 is part of the processing optic 124 or integrated into the processing optic 124.

The scanner unit 132 comprises, for example, an acoustooptical deflector and/or a scanner mirror and/or a galvanometer scanner.

The machining system 100 further comprises a detection unit 134, by means of which a status of the feed unit 128 can be determined. The status of the feed unit 128 is understood, in particular, to mean the position x₀, y₀, z₀, orientation α₀ and/or the movement status v₀, a₀ of the workpiece 104 relative to the machining laser beam 102.

In particular, actual values and/or target values of the status of the feed unit 128 can be determined by means of the detection unit 134, i.e., actual statuses and/or target statuses of the feed unit 128 can be determined.

To determine the target status of the feed unit 128, data are read out from the feed unit 128 by means of the detection unit 134, for example, on the basis of which the feed unit 128 is used to control the workpiece 104 with regard to its position and/or its orientation and/or its movement status relative to the machining laser beam 102 at a specific point in time. For this purpose, the detection unit 134 is connected to the feed unit 128 in a signal-effective manner (indicated in FIG. 1).

In principle, it is also possible that the detection unit 134 is part of the feed unit 128 and/or is integrated into the feed unit 128. The detection unit 134 then has in particular the data of the feed unit 128, on the basis of which the control of the workpiece 104 takes place at a specific point in time.

In any case, the detection unit 134 provides the determined or existing data concerning the target status of the feed unit 128 for further processing.

To determine the actual status of the feed unit 128, the detection unit 134 can have a sensor unit 136. By means of this sensor unit 136, the actual status of the feed unit 128 with regard to position, orientation and/or movement status of the workpiece 104 relative to the machining laser beam 102 can be measured.

The sensor unit 136 is designed, for example, to detect measured values relating to the mount 126 and/or the scanner unit 132, from which the actual status of the feed unit 128 can be determined. In particular, the sensor unit 136 has one or more sensor elements 138, which are assigned, for example, to the mount 126 and/or the scanner unit 132.

A specific sensor element 138 can be formed, for example, as a position sensor, orientation sensor, speed sensor, acceleration sensor or temperature sensor.

During operation of the machining system 100, it is provided that the phase adjustment unit 114 is controlled in order to adjust the respective phase difference between the coherent laser beams 110 and/or the amplified coherent laser beams 122. Using the phase adjustment unit 114, it is possible in the example shown to adjust the respective phase difference between the coherent laser beams 110 that are coupled into the amplifying unit 118, which brings about a change in and/or adjustment of the respective phase difference between the corresponding amplified coherent laser beams 122.

To control the phase adjustment unit 114, the machining system 100 has a control unit 140 which is connected to the phase adjustment unit 114 in a signal-effective manner. The control unit 140 is designed to control the phase adjustment unit 114 with specific control values on the basis of an assignment rule. The assignment rule contains an assignment of target values of the respective phase difference between the coherent laser beams 110 and/or amplified coherent laser beams 122 to specific control values. For example, the assignment rule is or comprises an assignment table.

By means of the control unit 140, the respective phase difference between the coherent laser beams 110 and/or amplified coherent laser beams 122 can thus be adjusted to predetermined target values. This makes it possible to provide the machining laser beam 102 with predetermined properties for laser machining of the workpiece 104.

Furthermore, the control unit 140 is designed to control the phase adjustment unit 114 during operation of the machining system 100 according to the status, in particular the target status and/or the actual status, of the feed unit 128. In particular, the control unit 140 is designed to adjust the respective phase difference between the coherent laser beams 110 and/or amplified coherent laser beams 122 according to the status of the feed unit 128.

The control unit 140 is, for example, connected to the detection unit 134 in a signal-effective manner in order to obtain information regarding the status, in particular the target status and/or the actual status, of the feed unit 128 during operation of the machining system 100. Based on this information, the control unit 140 then adjusts the respective phase difference between the coherent laser beams 110 or amplified coherent laser beams 122 to predetermined target values by correspondingly controlling the phase adjustment unit 114.

For this purpose, for example, a further assignment rule can be provided which contains an assignment of the status of the feed unit to the desired target values of the respective phase difference. This further assignment rule can, for example, contain several predefined parameter sets for the phase differences to be adjusted, which are selected according to the status of the feed unit 128.

A main propagation direction 142 of the coherent laser beams 110 and/or the amplified coherent laser beams 122 and/or the input laser beam 108 and/or the machining laser beam 102 through the machining system 100 is indicated by an arrow in FIG. 1.

The machining system 100 functions as follows:
during operation of the machining system 100, a plurality of coherent laser beams 110 are provided by means of the laser beam source 106. In the example shown in FIG. 1, an input laser beam 108 is initially generated with the laser beam source 106 and this is split into the coherent laser beams 110 by means of the splitting device 112.

In the example shown, the provided coherent laser beams 110 then pass through the phase adjustment unit 114 and then the amplifying unit 118, wherein the amplified coherent laser beams 122 are formed by amplifying the coherent laser beams 110 by means of the amplifying unit 118.

The amplified coherent laser beams 122 are coupled into the processing optic 124 and combined and focused by means of the latter in order to form the at least one machining laser beam 102. The machining laser beam 102 is introduced into and/or focused on the workpiece 104 for laser machining thereof.

In order to form the machining laser beam 102 or machining laser beams 102 with the desired properties, it is necessary to match the respective phase differences between the amplified coherent laser beams 124 before combining them. For this purpose, these phase differences are adjusted by controlling the phase adjustment unit 114 by means of the control unit 140.

For laser machining of the workpiece 104, the at least one machining laser beam 102 and in particular its focus or focus zone is introduced into the workpiece 104 as a function of time at predetermined positions x₀, y₀, z₀ and/or with predetermined orientations α₀ and/or movement statuses v₀, a₀, or is oriented relative to or moved relative to the workpiece. The corresponding control of the machining laser beam 102 relative to the workpiece 104 is carried out by means of the feed unit 128, which is programmed accordingly, for example, for a specific laser machining process of the workpiece 104.

The control unit 140 is, as explained above, designed to adjust the phase differences according to the status of the feed unit 128. For this purpose, the control unit 140 receives corresponding information from the detection unit 134.

The detection unit 134 determines the status of the feed unit 128, i.e., its actual status and/or target status, by reading information from the feed unit 128 itself and/or from the sensor elements 138 of the sensor unit 136.

The status of the feed unit 128 is understood to mean, in particular, the position x₀, y₀, z₀ and/or orientation α₀ and/or movement status v₀, a₀ of the workpiece 104 relative to the machining laser beam 102 acting on the workpiece 104.

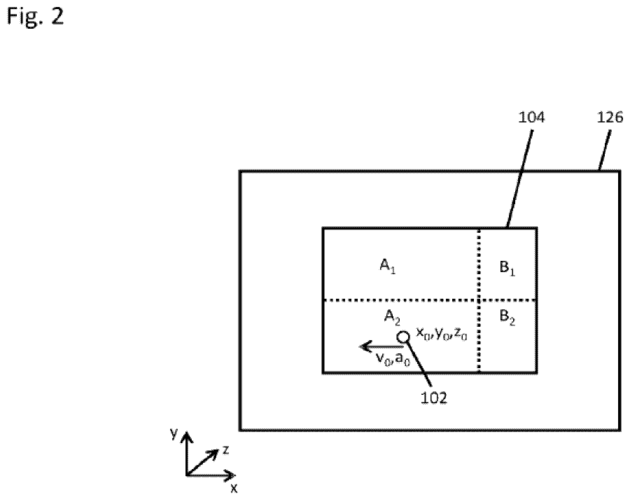

For example, the workpiece can have four different regions A₁, A₂, B₁ and B₂ which are shown schematically in FIG. 2 and whose spatial boundaries are represented by the dashed lines. The feed unit 128 can then be configured, for example, so that the workpiece 104 is exposed to the machining laser beam 102 in the regions A₁, B₁, B₂ and A₂ in chronological succession in order to carry out a laser machining operation.

By detecting the current set position and/or actual position of the machining laser beam 102 by means of the detection unit 134 and forwarding this information to the control unit 140, the latter can control the phase adjustment unit 114, for example, in such a way that, according to the respective region A₁, A₂, B₁, B₂ of the workpiece 104 in which the machining laser beam 102 is currently positioned, the respective phase differences between the amplified coherent laser beams 122 are adjusted to different values. For example, it may be provided that a first predefined set of parameters is adjusted for the respective phase differences for regions A₁ and A₂ and a second predefined set of parameters is adjusted for the regions B₁ and B₂.

By adjusting the respective phase differences, properties of the existing machining laser beams 102 can be defined, such as their respective intensity. In the example shown, the predefined parameter sets could, for example, be selected so that the machining laser beam 102 in the regions A₁ and A₂ or B₁ and B₂ has different intensities.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

A₁, A₂ Regions of the workpiece
B₁, B₂ Regions of the workpiece
x₀, y₀, z₀ Position
v₀ Speed
a₀ Acceleration
α₀ Incidence angle
100 Machining system
102 Machining laser beam
104 Workpiece
106 Laser beam source
108 Input laser beam
110 Coherent laser beam
112 Splitting device
114 Phase adjustment unit
116 Phase adjustment element
118 Amplifying unit
120 Amplifying element
122 Amplified coherent laser beam
124 Processing optic
126 Mount
128 Feed unit
130 Reference plane
132 Scanner unit
134 Detection unit
136 Sensor unit
138 Sensor element
140 Control unit
142 Main propagation direction

1. A machining system for laser machining a workpiece, the machining system comprising:
at least one laser beam source for providing a plurality of coherent laser beams,
a phase adjustment unit for adjusting a respective phase difference between the plurality of coherent laser beams,
an amplifier for amplifying the plurality of coherent laser beams to form respective amplified coherent laser beams,
a processing optic for combining the amplified coherent laser beams to form at least one machining laser beam and for applying the workpiece with the at least one machining laser beam,
a feed unit for controlling a position and/or an orientation and/or a movement status of the workpiece relative to the at least one machining laser beam,
a detection unit for determining a status of the feed unit, and
a control unit configured to control the phase adjustment unit according to the status of the feed unit as determined by the detection unit.

2. The machining system according to claim 1, wherein the status of the feed unit comprises at least one of:
a position of the workpiece relative to the at least one machining laser beam;
an orientation of the workpiece relative to the at least one machining laser beam,; or
a speed and/or an acceleration of the workpiece relative to the at least one machining laser beam.

3. The machining system according to claim 1, wherein the control unit is configured to adjust the respective phase difference between the plurality of coherent laser beams and/or between the amplified coherent laser beams as a function of the status of the feed unit by controlling the phase adjustment unit.

4. The machining system according to claim 1, wherein the status of the feed unit determined by the detection unit is an actual status and/or a target status of the feed unit.

5. The machining system according to claim 1, wherein the feed unit comprises a scanner, which comprises an acoustooptical deflector and/or a scanner mirror and/or a galvanometer scanner.

6. The machining system according to claim 1, further comprising a mount for arranging and/or fixing the workpiece, wherein the feed unit is configured to move and/or to orientate the workpiece arranged on the mount relative to the at least one machining laser beam.

7. The machining system according to claim 1, wherein the detection unit comprises a sensor for determining an actual status of the feed unit, wherein the sensor is assigned to one or more components of the machining system which are configured to move and/or to orientate the at least one machining laser beam relative to the workpiece.

8. The machining system according to claim 1, wherein the detection unit is configured to read out and/or process data from the feed unit in order to determine a target status of the feed unit.

9. The machining system according to claim 1, wherein the control unit is configured to control of the phase adjustment unit based on a predetermined assignment rule, wherein the assignment rule has at least two different predefined parameter sets which are selected depending on the status of the feed unit determined by the detection unit.

10. The machining system according to claim 1, wherein the plurality of coherent laser beams provided by the laser beam source are pulsed laser beams and/or wherein the at least one machining laser beam is a pulsed laser beam.

11. A method for laser machining of a workpiece, the method comprising:
providing a plurality of coherent laser beams,
adjusting a respective phase difference between the plurality of coherent laser beams,
amplifying the plurality of coherent laser beams to form respective amplified coherent laser beams,
combining the amplified coherent laser beams to form the at least one machining laser beam, and applying the at least one machining laser beam to the workpiece,
controlling a position and/or an orientation and/or a movement status of the workpiece relative to the at least one machining laser beam using a feed unit,
determining a status of the feed unit by using a detection unit, and
controlling the phase adjustment unit by using a control unit, the control unit being configured to control the phase adjustment unit according to the status of the feed unit determined by the detection unit.
